(19) United States
(12) Patent Application Publication
(10) Pub. No.: US 2012/0074682 A1
(43) Pub. Date: Mar. 29, 2012

(54) METHOD FOR CREATING A VISUAL ANIMATION ON A MEDIUM

(75) Inventor: Henri Rosset, Le Pin (FR)

(73) Assignee: ARJOWIGGINS SECURITY, Paris, FR (FR)

(21) Appl. No.: 13/201,645

(22) PCT Filed: Feb. 16, 2010
(86) PCT No.: PCT/IB2010/050679

§ 371 Date: Oct. 28, 2011

(30) Foreign Application Priority Data
Feb. 16, 2009 (FR) 09/50960

(51) Int. Cl. B42D 15/00; B44F 1/12; B05D 5/06

(52) U.S. Cl. 283/72; 427/145

(57) ABSTRACT

The invention relates to a method for creating a visual animation on a medium, including the following steps consisting in: disposing at least two excitable agents on the medium in at least two adjacent respective zones, each of said agents generating a visual effect in response to the same stimulus and said visual effects having different appearances and/or afterglows. The excitable agents are selected such that the visual effects appear and/or disappear sufficiently close to one another over time so as to give the observer the impression of movement on the medium.

The present invention relates to the use of excitable phosphorescent, photochromic or thermochromic agents. The invention relates more particularly although not exclusively to the use of such excitable agents for making media, such as security documents for example, more secure.

There is a need for security elements the presence of which is readily detectable by the general public and which are capable of being attractive by creating novel optical effects.

The use of phosphorescent, photochromic or thermochromic agents to make documents more secure is already known.

For example, patent U.S. Pat. No. 4,500,116 describes a security document comprising a phosphorescent composition including two phosphorescent agents which emit at different wavelengths and which have different remanence times such that following excitation of the composition, the light emitted by phosphorescence progressively changes color for example changes from green to blue.

Application WO 97/31784 describes a security document comprising a latent image that is normally invisible and that appears when the document is heated.

Application WO 98/28154 describes a security element comprising a photochromic coloring agent.

U.S. Pat. No. 4,708,817 describes the use of a phosphorescent composition to create patterns that are invisible under natural light but become visible in the dark.

U.S. Pat. No. 6,375,8645 describes phosphorescent compositions capable of emitting in the visible spectrum.

The present invention, in one of its aspects, relates to a method for creating a visual animation on a medium, comprising the steps involving:
arranging on the medium, in at least two respective adjacent zones, at least two excitable agents each generating a visual effect in response to one and the same stimulus, the visual effects having different remanence and/or appearance times, the excitable agents being chosen so that the visual effects appear and/or disappear sufficiently close together in time that an observer is given an impression of movement across the medium.

Said at least two agents respectively arranged in said at least two adjacent zones are therefore excitable by one and the same stimulus. The excitation may cause a change in appearance or a change in state of an agent which can be measured physically using a suitable detector, which means to say that the change in state or in appearance can be detected by measuring light intensity or radiation for example. The change in appearance or in state is “real”, precisely located within the adjacent zones and not connected with any optical illusion. In this regard, the method for creating a visual animation according to the invention differs from “imaginary” optical illusion, associated for example with the fatigue or movement of the human eye looking at a stationary image that depicts a periodic pattern.

The visual effects may follow one another in a space of time of between 100 ms and 3 s, for example of around 2 seconds, the total appearance or disappearance time of the visual effects being less than 30 seconds for preference, or even less than or equal to 10 seconds. For example, in the first zone, a first visual effect may appear while in the adjacent zone the visual effect is not yet visible, and the visual effect may appear in said adjacent zone after a space of time of between 1 and 3 seconds, for example of the order of 2 seconds, following the appearance of the first visual effect. One of the visual effects may be completely visible before the other visual effect begins to appear.

As an alternative, the visual effect may appear in the two zones and, after the stimulus has disappeared, one of the visual effects may disappear before the other, the offset in time in the disappearance of the visual effects being, for example, less than or equal to 2 seconds. One of the visual effects may notably have disappeared for the observer before the other visual effect disappears.

The visual effects may correspond to the same color or to different colors and, in the case of the same color, to the same brightness or to different brightnesses.

When photochromic agents are used, the use of UV filters mixed at different concentrations with the photochromic agents of the various zones or superposed in the various zones with the photochromic agents at different thicknesses and/or concentrations allows the stimulus reaching the excitable agents to be attenuated and therefore makes it possible to create an offset in time between the appearances of the visual effects.

In the case of thermochromic agents, by creating a more or less thermally insulating barrier on at least one side of the coloring agent, in one of the zones, it is possible to delay the change in appearance with respect to the other zone, in the presence of a heat source.

By contrast, again in the case of thermochromic agents, by creating a more or less thermally conducting layer, for example a metallic layer, on at least one side of the coloring agent, in one of the zones, it is possible to accelerate the change in appearance with respect to the other zone, in the presence of a heat source. In order to obtain this accelerating effect, the thermally conducting layer may be more conductive than the medium.

In another of its aspects, another subject of the invention is a medium comprising at least two excitable agents arranged in adjacent respective zones, each of these agents generating a visual effect in response to one and the same stimulus, the remanence and/or appearance times of the visual effects being different and chosen so as to create an impression of movement in the eyes of the observer.

The excitable agents are, for example, photochromic, phosphorescent or thermochromic agents.

By way of thermochromic agents, use may be made of the compounds of the Chromazone® range, marketed by LAMBERTI, those of the Chromicolor® Aqualite range by MATSUI, those in powder or dispersion form marketed by A.I.C. or Davis Liquid Crystal, or even those notably in the form of thermochromic capsules marketed by the French company GEM'INNOV.

By way of photochromic agents, use may be made of those of the Photopia® range by MATSUI or photochromic capsules by GEM'INNOV.

The excitable agents have, for example, different visual-effect remanence times and/or different visual-effect appearance times.

The medium may comprise at least one filter that attenuates the optical stimulus in the case of a photochromic agent, notably a UV filter, so as to delay the appearance of the visual effect and create an offset in the appearance of the visual effect between the various zones.

For example, by way of UV filter, use may be made of materials in the phenyltriazine or benzophenone class or materials described in patent application EP 1 719 637.

When thermochromic coloring agents are used, the medium may comprise at least one thermally insulating barrier on and/or under the excitable agent, so as to slow down the transmission of heat from a source external to the medium toward the excitable agent.

For example, the thermally insulating barrier may comprise a layer or print of a preparation containing particles which slow down heat transfer, such as phase-change materials, for example BASF's Micronal products, hollow sphere plastic pigments such as Ropaque Ultra E or glass microspheres such as 3M's Scotchlite.

By contrast, when thermochromic coloring agents are being used, the medium may comprise at least one thermally conductive layer on and/or under the excitable agent in one of the zones, notably a layer that is more conductive than the medium such as a metallic layer, so as to accelerate the transmission of heat from a source external to the medium toward the excitable agent.

The medium preferably comprises at least three zones including respective excitable agents that have different remanence and/or appearance times for the visual effects, these zones preferably being arranged in an order that corresponds to the order in which the visual effects appear or disappear, so as to generate an impression of movement from the first zone to the last zone, or vice versa.

The various zones may be juxtaposed, contiguous or non-contiguous, concentric or non-concentric, arranged in a path that can be of any form and which for example extends in a straight line, a spiral, or any other curved or broken line. Two adjacent zones supporting excitable agents with an offset in the appearance and/or disappearance of the visual effects may be separated by less than 10 mm, preferably less than 2 mm All the zones intended to create the animation may be less than 10 mm apart across the document, preferably less than 2 mm apart.

The medium may comprise a plurality of patterns each produced with at least two zones as hereinabove, so that upon or following exposure to the stimulus, several patterns may each simultaneously create an impression of movement.

These patterns may be identical and create an impression of movement in one and the same direction or, as an alternative, be produced in such a way that the created impressions of movement are in opposite directions, according to the way in which the various excitable agents are arranged within the patterns.

The invention may be better understood from reading the detailed description which will follow of some non limiting exemplary embodiments thereof and from studying the attached drawing in which:

FIG. 1 schematically depicts one example of a security document produced according to the invention,

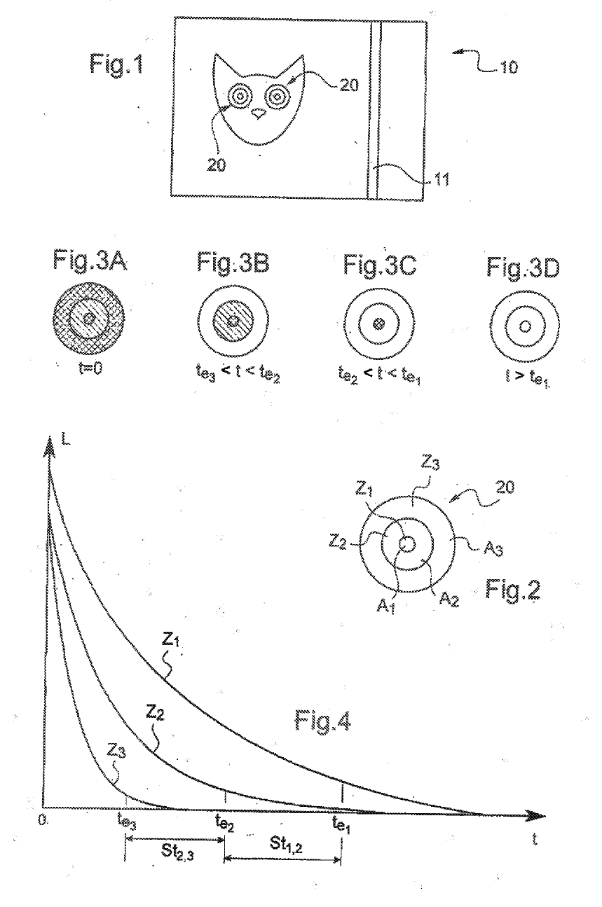

FIG. 2 depicts, in isolation, a security element according to the invention,

FIGS. 3A to 3D illustrate a sequence in which the visual effects disappear once the luminous excitation has ceased,

FIG. 4 depicts the change in light intensity emitted by phosphorescence as a function of time, for various examples of excitable agents intended to create an animation,

FIGS. 5 to 8 illustrate examples of arrangements of various zones comprising excitable agents across the document,

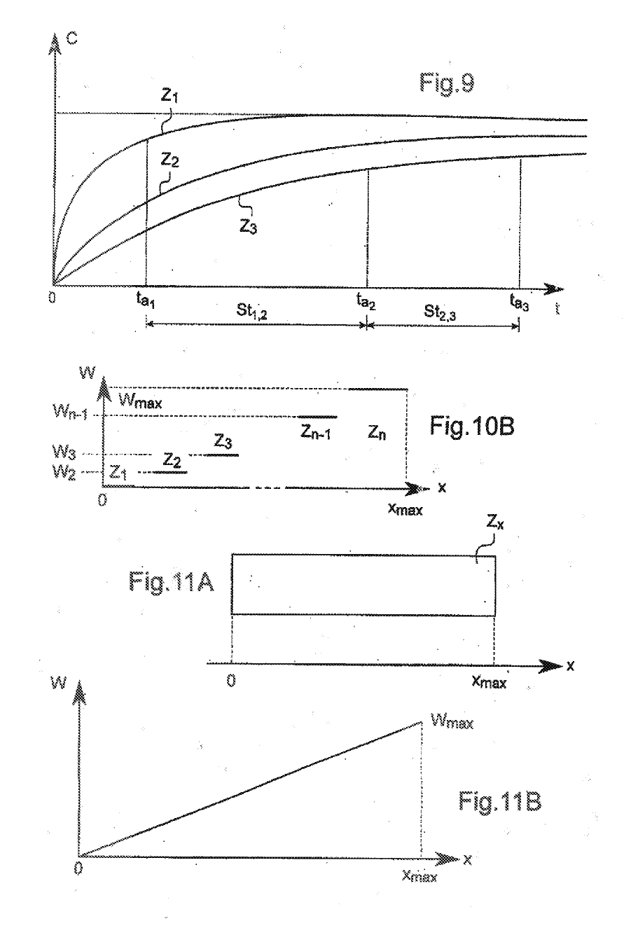

FIG. 9 illustrates the appearance of visual effects which are offset over time for various excitable agents intended to create an animation,

FIGS. 10A and 10B on the one hand, and 11A and 11B on the other, illustrate two examples of layouts of excitable agents,

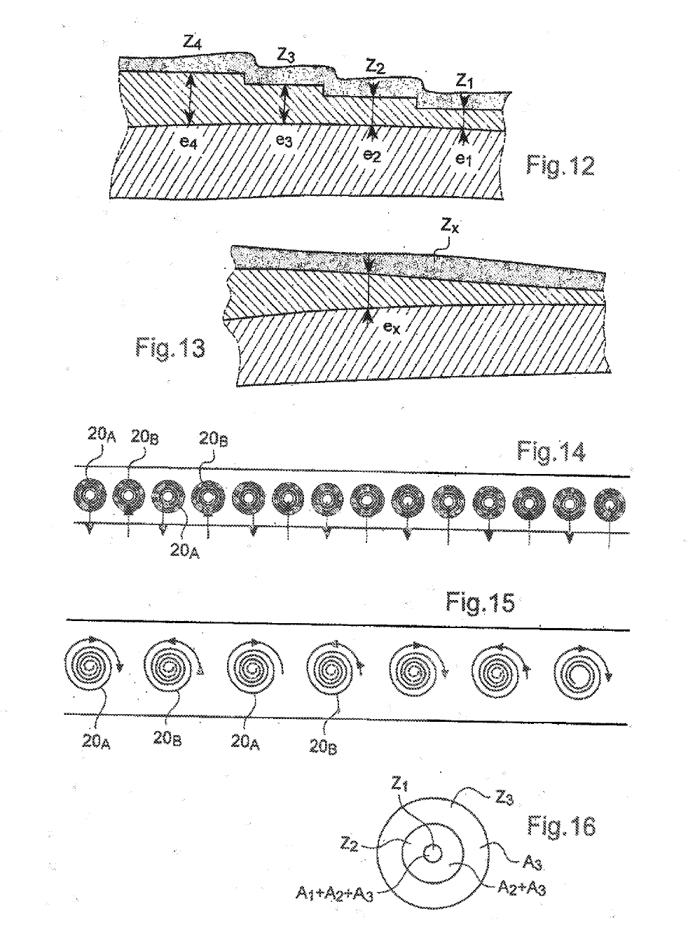

FIGS. 12 and 13 are cross sections illustrating exemplary embodiments of a thermally insulating barrier between one side of the document and one or more excitable agents, and

FIGS. 14 and 15 illustrate examples of arrangements of security elements in the form of patterns.

FIG. 1 depicts an example of a document 10 which, for example, is chosen from security documents, printing-writing papers, for example letterheads, art paper, paper for water colors or packaging, notably packaging intended to contain luxury goods.

The security document can be chosen from identity documents, particularly an identity card or a passport, payment means, particularly banknotes, checks, vouchers or coupons for making purchases, entry tickets for cultural or sporting events, and transport tickets.

It may also be a security document chosen from certificates of authenticity, warranty certificates or secure packaging, notably for drugs, electronic components, component parts, perfumes and secure labels.

The security document 10 comprises at least one security element 20 produced according to the invention, and in this instance two security elements 20 arranged like the eyes of a character in the example illustrated in FIG. 1.

The security document 10 may comprise any other security element 11 known from elsewhere and notably chosen from among:
luminescent pigments and/or colorants and/or interferential pigments and/or liquid-crystal pigments, notably in printed form,
photochromic or thermochromic pigments and/or colorants, notably in printed form,
a water mark,
a security wire or foil or patch,
a diffraction structure,
a birefringent or polarizing layer,
a tracer that can be read automatically and that has specific and measurable luminescence (for example fluorescence, phosphorescence) light-absorption (for example ultraviolet, visible or infrared light-absorption), Raman activity, magnetism, microwave interaction, X-ray interaction or electrical conductivity characteristics, and any combination of these security elements with one another or with other security elements,
an electronic device (for example an electronic chip).

FIG. 2 depicts in isolation one of the security elements 20. The latter comprises several zones, for example three zones Z1 to Z3, each comprising an excitable agent A1 to A3. These various zones are arranged in such a way that a visual effect connected with each excitable agent appears in response to a stimulus while at the same time creating an impression of movement in the eyes of the observer, thanks to an offset in the appearance and/or disappearance of the visual effects.

More particularly, the excitable agents may be sensitive to an optical stimulus, for example UV or visible light, and contain phosphorescent agents so that after the stimulus has disappeared they admit visible light.

The excitable agents are, for example different, and each associated with a respective zone of the security element, so that they have different decay times t^{e}, as illustrated in FIG. 4.

The decay time t^{e} can be defined as being the time needed from the disappearance of the light stimulus for the light emitted by the excitable agent to reach an intensity corresponding to Lₘₐₓ/k, with k equal to 10, where Lₘₐₓ is the light intensity at the moment that the stimulus ceases.

In FIG. 4, it can be seen that the excitable agent A1 present in the zone Z1 is the one that emits light for the longest time, once the stimulus has disappeared, having a decay time t^{e1}.

The third zone Z3 corresponds to an excitable agent A3 which has the shortest decay time t^{e3} and the zone Z2 corresponds to an excitable agent A2 that has a decay time t^{e2} somewhere between t^{e1} and t^{e3}.

The differences Δt^{1,2} between the decay times t^{e1} and t^{e2}, and Δt^{2,3} between the decay times t^{e2} and t^{e3} are short enough that the user, when looking at the security element 20, has the impression of movement. For example in general, Δt^{ei,ei+1} is less than or equal to 10 seconds, notably of the order of a few seconds, for example 2 seconds, or even less than 1 second, for example 100 ms, the entire pattern disappearing in under 45 s, for example in the order of 30 seconds for example.

In the example of FIG. 2, once the light stimulus has disappeared, light emitted by all three zones Z1 to Z3 is first of all seen, as illustrated in FIG. 3, and then once the decay time t^{e3} has elapsed, the observer sees only the two central zones Z1 and Z2. Once the delay time t^{e2} is reached, the user then sees only the central zone Z1, and after the decay time t^{e1} the entire security element is no longer illuminated.

The excitable agents corresponding to the various zones Z1 to Z3 may emit in the same color or, as an alternative, may emit at different wavelengths.

One and the same zone may notably contain two excitable agents of different colors and with different decay times.

It is even possible to have excitable agents other than phosphorescent ones which appear after different initiation times with different colors within one and the same region.

In an alternative form illustrated in FIG. 16, the zone Z3 contains only the excitable agent A3, whereas the zone Z2 contains the excitable agent A2 and the excitable agent A3, and the zone Z1 contains all three excitable agents A1 to A3.

When the agents A1 to A3 emit at different wavelengths, an additional visual effect is obtained which is connected with the variation in color of the zones Z1 and Z2 as the effect of the excitable agent A3 decays, then with the variation in color in the zone Z1 as the effect of the agent A2 decays.

The various zones can be set out in numerous ways, for example in curved or straight lines. By way of example, FIG. 5 illustrates the arrangement of the various zones Z1 to Zn in a spiral path.

The most central zones correspond for example to those which have the highest decay time t^{e} which means that when the excitation ceases, the observer sees effects in the various zones decay from the periphery toward the center. Of course the reverse arrangement is possible. Likewise a spiral or some other path may be created with excitable agents other than phosphorescent ones, for example with an initiation time that increases toward the center or vice versa.

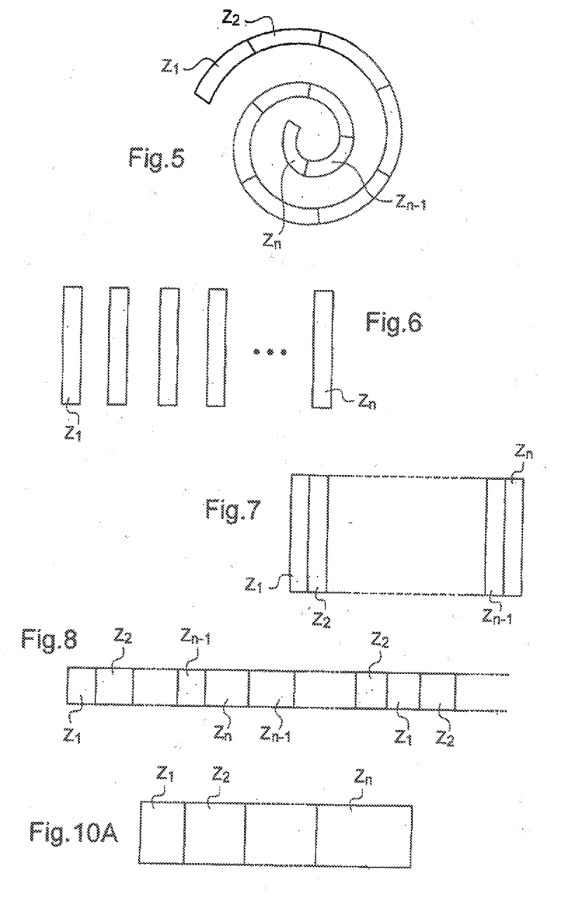

FIG. 6 illustrates the possibility of arranging the various zones Z1 to Zn non-contiguously, for example in the form of parallel bars, and FIG. 7 illustrates the possibility of arranging the various zones Z1 to Zn contiguously, for example likewise in the form of parallel bars.

A certain number of zones Z1 to Zj may be arranged in an order that corresponds, for example, to an increasing decay time t^{ei} >t^{ei-1} when progressing in one and the same direction, then with a decreasing decay time for the next zones Zj+1 to Zk where t^{ei}<t^{e-1} and so on, as illustrated in FIG. 8 or, as an alternative, in which the decay times increase and decrease alternately.

According to one aspect of the invention, the excitable agents are phosphorescent agents, but it would not constitute a departure from the scope of the present invention if the excitable agents were not phosphorescent agents but photochromic or thermochromic agents that generate a visual effect that manifests itself after the stimulus has appeared. According to the invention, the excitable agents may also comprise a mixture of one or more phosphorescent agents.

For example, the excitable agent is a photochromic agent which changes color under the effect of an optical stimulus, for example UV light, or which changes from pale to dark or vice versa under the effect of this stimulus.

The excitable agent may even be a thermochromic agent which changes color as the temperature increases, for example changing from one color to another or from a colored state to a colorless state or from the colorless state to the colored state.

The increase in temperature is connected, for example, with contact with an individual or with any other heat source.

For preference, the excitable agent is such that the visual effect that appears is reversible, which means to say that the excitable agent ultimately reverts to the same un-excited state as it had before the stimulus.

In the case of a security element 20 comprising three zones Z1 to Z3 comprising photochromic excitable agents with initiation times t^{a1} to t^{a3} that differ for the three zones Z1 to Z3 there may be seen, for example, as illustrated in FIG. 9, that when the security element 20 is exposed to UV light, first of all zone Z1 changes appearance by virtue of the fact that the excitable agent A1 is the one that has the shortest initiation time ta1, then zone Z2 changes appearance, the excitable agent A2 having an initiation time ta2 that is somewhere between the times ta1 and ta3, followed finally by a change in appearance of zone Z3.

The changes in appearance of the various zones may be more or less pronounced, which means to say that when the zone Z1 is perceived by the observer as having changed appearance, this observer may, depending on circumstance, have also observed a less pronounced change in appearance of the other zones.

For preference, in order for the movement effect to be as spectacular as possible, when one zone Zi has changed appearance, the adjacent zone Zi+1 which is intended to change appearance later has not yet experienced a significant change in appearance. In order to obtain a response to the stimulus corresponding to different initiation times t^{a}, one solution is to use different excitable agents that have increasing respective initiation times t^{ai}.

Another solution may involve using one and the same excitable agent but mixed with a filter which, depending on its concentration, attenuates the stimulus or, on the other hand, activates it to greater or lesser extents.

For example, the excitable agent can be mixed with a greater or lesser concentration of UV filter or, as an alternative, the excitable agent may be covered with a layer of greater or lesser thickness of UV filter or a layer of greater or lesser concentration of UV filter, or a layer that contains a UV filter of greater or lesser effectiveness. In the exemplary embodiments of the invention, various zones Z1 to Zn may, as illustrated in FIGS. 10A et 10B, correspond to different concentrations wⁱ of a stimulus-attenuating agent, the concentrations wⁱ varying discontinuously from one zone to another, for example in an increasing manner.

In alternative forms of embodiment of the invention, the concentration of stimulus-attenuating agent may, as illustrated in FIGS. 11A and 11B, vary in a way that is continuous in one direction, making it possible to obtain an extended zone Zx of which the initiation time ta(x) is dependent on the x-coordinate in that direction.

In the case of a thermochromic excitable agent, a barrier of variable thermal conductivity can be created, for example between the excitable agent and one side of the medium that is intended to be placed in contact with the heat source intended to excite the excitable agent.

In the example of FIG. 12, it may be seen that the barrier can be produced in the form of a graduated layer with different thicknesses e1 to e4 under different respective zones Z1 to Z4, so that the zone Z1 is brought up to a given temperature more rapidly than the zone Z4. Thus, the zone Z1 may change appearance more rapidly than the zone Z4 and a visual effect of animation between the various zones Z1 to Z4 may be obtained. Of course, the number of zones is not restricted to four and may, for example, range from 2 to 10.

In the example of FIG. 13, the thickness e(x) of the thermal barrier varies continuously with the x-coordinate and an extended zone Zx is obtained in which the initiation time ta(x) likewise varies continuously in the x-direction.

FIGS. 14 and 15 illustrate the possibility of arranging several security elements produced according to the invention in the form of juxtaposed patterns 20A and 20B, these patterns for example being borne by a security thread incorporated into windows in the paper mass.

The patterns may be identical or, as an alternative, different, so as for example to create impressions of movement in opposite directions with, for example, remanence from the inside outward for the elements 20A and the opposite for the elements 20B in FIG. 14, and movement toward the center for the elements 20B and the opposite for the elements 2A in FIG. 15. The patterns 20A and 20B may be of the same shape.

Of course, the invention is not restricted to the examples that have just been described. One and the same medium may combine different security elements intended to give an impression of movement in response to different respective stimuli.

The expression “comprising a/an/one” is to be understood as being synonymous with “comprising at least one” unless specified to the contrary.

1. A method for creating a visual animation on a medium, comprising:
arranging on the medium, in at least two respective adjacent zones, at least two excitable agents each generating a visual effect in response to one and the same stimulus, the visual effects having different remanence and/or appearance times, the excitable agents being chosen so that the visual effects appear and/or disappear sufficiently close together in time that an observer is given an impression of movement across the medium.

2. The method as claimed in claim 1, the visual effects following one another in a space of time of less than or equal to 3 s.

3. The method as claimed in claim 1, in which in the first zone, a first visual effect appears while in the adjacent zone the visual effect is not yet visible, and in which a second visual effect appears in the adjacent second zone after a space of time of between 100 ms and 3 s after the appearance of the first visual effect.

4. The method as claimed in claim 1, in which one of the visual effects is completely visible before the other visual effect begins to appear.

5. The method as claimed in claims 1, in which the visual effect appears in the two zones and, after the stimulus has disappeared, one of the visual effects disappears before the other, the offset in time in the disappearance of the visual effects being less than or equal to 2 s.

6. The method as claimed in claim 5, one of the visual effects having disappeared for the observer before the other visual effect disappears.

7. The method as claimed in claim 1, the visual effects corresponding to the same color.

8. The method as claimed in claim 1, the visual effects corresponding to different colors.

9. The method as claimed in claim 1, the excitable agents being photochromic agents.

10. The method as claimed in claim 9, in which UV filters are mixed at different concentrations with the excitable agents or are superposed on the excitable agents in order to attenuate the stimulus reaching one of the excitable agents and create an offset in time between the appearances of the visual effects.

11. The method as claimed in claim 1, the excitable agents being thermochromic agents.

12. The method as claimed in claim 11, in which a thermally insulating barrier is created on at least one side of the coloring agent, in one of the zones, so as to delay the change in appearance with respect to the other zone, in the presence of a heat source.

13. A medium comprising two excitable agents arranged in adjacent respective zones, each of these excitable agents generating a visual effect in response to one and the same stimulus, the remanence and/or appearance times of the visual effects being different and chosen so as to create an impression of movement in the eyes of the observer.

14. The medium as claimed in claim 13, the excitable agents being photochromic agents.

15. The medium as claimed in claim 13, the excitable agents being phosphorescent agents.

16. The medium as claimed in claim 13, the excitable agents being thermochromic agents.

17. The medium as claimed in claim 14, comprising at least one filter that attenuates the optical stimulus in one of the zones.

18. The medium as claimed in claim 16, comprising a thermally insulating barrier on and/or under the excitable agent in one of the zones.

19. The medium as claimed in claim 16, comprising a thermally conducting barrier on and/or under the excitable agent in one of the zones.

20. The medium as claimed in claim 13, comprising at least three zones including respective excitable agents that have different remanence and/or appearance times for the visual effects, these zones being arranged in an order that corresponds to the order in which the visual effects appear or disappear, so as to generate an impression of movement from the first zone to the last zone, or vice versa.

21. The medium as claimed in claim 13, the various zones being juxtaposed.

22. The medium as claimed in claim 13, the various zones being contiguous.

23. The medium as claimed in claim 13, the zones being arranged in a spiral.

24. The medium as claimed in claim 13, two adjacent zones supporting excitable agents with an offset in the appearance and/or disappearance of the visual effects being separated by less than 10 mm.

25. The medium as claimed in claim 13, comprising a plurality of patterns each produced with at least two of said zones, so that upon exposure to the stimulus, several patterns each simultaneously create an impression of movement.

26. The medium as claimed in claim 24, the patterns being identical and creating an impression of movement in one and the same direction.

27. The medium as claimed in claim 24, the patterns being produced in such a way that the created impressions of movement are in opposite directions.
